(19) United States
(12) Patent Application Publication
(10) Pub. No.: US 2013/0083721 A1
(43) Pub. Date: Apr. 4, 2013

(54) BASE STATION AND TRANSMISSION PATH CREATION METHOD THEREOF

(71) Applicant: Institute For Information Industry, Taipei (TW)

(72) Inventors: Chih-Chiang WU, Taichung City (TW); Kanchei Loa, Taipei City (TW); Shu-Tsz LIU, Taipei City (TW); Hsien-Tsung HSU, Taipei City (TW)

(73) Assignee: INSTITUTE FOR INFORMATION INDUSTRY, Taipei (TW)

(21) Appl. No.: 13/632,039

(22) Filed: Sep. 30, 2012

Related U.S. Application Data
(60) Provisional application No. 61/542,154, filed on Oct. 1, 2011.
(60) Provisional application No. 61/606,505, filed on Mar. 5, 2012.

(51) Int. Cl. H04W 36/00; H04W 88/16; H04W 88/04

(52) U.S. Cl. 370/315

(57) ABSTRACT

A base station and a transmission path creation method for use in a network system are provided. A first packet data network (PDN) connection has been built among an user equipment serving gateway (UE-SGW), a first relay gateway, a first packet data network gateway (P-GW), a first serving gateway (S-GW), a first E-UTRAN Node B (eNodeB) and the relay node of the network system. The base station comprises a second relay gateway, a second P-GW, a second S-GW, and a second eNodeB. The second eNodeB and a relay node execute a handover procedure according to a handover request. The network system performs a transmission path creation procedure so that a second PDN connection is formed among the UE-SGW, the second relay gateway, the second P-GW, the second S-GW, a second eNodeB and the relay node.

### PRIORITY

This application claims the benefit of U.S. Provisional Application Ser. No. 61/542,154 filed on Oct. 1, 2011 and U.S. Provisional Application Ser. No. 61/606,505 filed on Mar. 5, 2012, both of which are hereby incorporated by reference herein in their entirety.

### FIELD

The present invention relates to a base station and a transmission path creation method thereof; and more particularly, the base station and the transmission path creation method thereof according to the present invention are adapted to process transmission paths of stations after handover.

### BACKGROUND

With the rapid development of science and technologies, wireless communication technologies have been widely applied in various environments. In order to provide a wider service scope, the primary wireless communication technologies all adopt relay technologies to provide a handover mechanism for moving stations and to correspondingly process transmission paths of the stations after handover. However, for the stations moving at a high speed, the conventional processing mechanism has shortcomings Now, the shortcomings of the conventional processing mechanism in the high-speed moving environment will be described with the Long Term Evolution (LTE) technology as an example.

In the LTE architecture, a relay node (RN) may be deployed in a carriage of a train moving at a high speed to serve user equipment (UE) in the carriage. As the train moves rapidly, the relay node is necessarily handed over to other base stations successively. In the LTE architecture, each base station comprises a relay gateway, an eNode B, a serving gateway and a packet data network gateway. At an initial stage, the relay node connects with an initial base station, and transmits data via the serving gateway and the packet data network gateway of the initial base station. As the train moves, the relay node is handed over to a target base station, and then transmits data via the eNode B of the target base station and the serving gateway and the packet data network gateway of the initial base station. Alternatively, after being handed over to the target base station, the relay node transmits data via the eNode B and the serving gateway of the target base station and the packet data network gateway of the initial base station. However, no matter which manner is adopted, the data must be transmitted via the packet data network gateway of the initial base station in the prior art. As the train moves continuously, the distance between the target base station and the initial base station increases and, consequently, the data transmission path is elongated, thereby causing a long transmission delay.

In view of this, an urgent need exists in the art to enable stations moving at a high speed to transmit data efficiently after handover.

### SUMMARY

To solve the aforesaid problem, the present invention provides a base station and a transmission path creation method thereof.

The base station of the present invention is for use in a network system. The network system according to certain embodiments comprises the base station, a relay node, a user equipment serving gateway (UE-SGW), a first relay node mobility management entity (RN-MME), a first relay gateway, a first packet data network gateway (P-GW), a first serving gateway (S-GW) and a first E-UTRAN Node B (eNode B). A first packet data network (PDN) connection is formed among the UE-SGW, the first relay gateway, the first P-GW, the first S-GW, the first eNode B and the relay node. The relay node communicates data with the UE-SGW via the first PDN connection.

The base station comprises a second eNode B, a second relay gateway, a second P-GW and a second S-GW. The second eNode B is configured to execute a handover procedure with the relay node according to a handover request. The second relay gateway is configured to create a connection with the UE-SGW after the handover procedure. The second P-GW is configured to create a connection with the second relay gateway after the handover procedure. The second S-GW is configured to execute a connection establish procedure with the second P-GW and to create a connection with the second eNode B after the handover procedure.

Thereby, the relay node communicates data with the UE-SGW via a second PDN connection after the handover procedure. The second PDN connection is formed among the UE-SGW, the second relay gateway, the second P-GW, the second S-GW, the second eNode B and the relay node.

The transmission path creation method of the present invention is adapted for use in a base station of a network system. The network system according to certain embodiments comprises the base station, a relay node, a UE-SGW, an RN-MME, a first relay gateway, a first P-GW, a first S-GW and a first eNode B. A first PDN connection is formed among the UE-SGW, the first relay gateway, the first P-GW, the first S-GW, the first eNode B and the relay node communicating data with the UE-SGW via the first PDN connection. The base station comprises a second eNode B, a second relay gateway, a second P-GW and a second S-GW.

The transmission path creation method according to certain embodiments comprises the following steps of: executing, by the second eNode B, a handover procedure with the relay node according to a handover request; creating a connection between the second relay gateway and the UE-SGW after the handover procedure; creating a connection between the second P-GW and the second relay gateway after the handover procedure; executing a connection establish procedure between the second S-GW and the second P-GW after the handover procedure; creating a connection between the second S-GW and the second eNode B after the handover procedure.

Thereby, the relay node can communicate data with the UE-SGW via a second PDN connection after the handover procedure. The second PDN connection is formed among the UE-SGW, the second relay gateway, the second P-GW, the second S-GW, the second eNode B and the relay node.

As can be known from the above descriptions, the base station and the transmission path creation method thereof according to certain embodiments of the present invention create a new PDN connection for a relay node after the relay node is handed over to the base station. Therefore, even though the distance from the relay node to the initial base station becomes too long due to movement of the train, the relay node can still transmit data via the new PDN connection. Thus, the problem with the prior art that the transmission path of the PDN connection becomes increasingly longer is solved, and the efficiency of data transmission is further improved.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A depicts a schematic view of a network system 1 of the present invention;

FIG. 1B depicts a functional block diagram of the network system 1 of the present invention;

FIG. 2A and FIG. 2B depict schematic views of signal transmissions according to a second embodiment;

FIG. 3A depicts a schematic view of a network system 3 according to the present invention;

FIG. 3B depicts a functional block diagram of the network system 3 according to the present invention;

FIG. 3C and FIG. 3D depict schematic views of signal transmissions according to a third embodiment of the present invention;

FIG. 4A depicts a schematic view of signal transmissions according to a fourth embodiment of the present invention;

FIG. 4B depicts a schematic view of correspondence relationships between data stored in a UE-MME and a relay node identification and a user equipment identification;

FIG. 5 depicts a schematic view of signal transmissions according to a fifth embodiment of the present invention;

FIG. 6 depicts a flowchart diagram of a sixth embodiment and a seventh embodiment of the present invention;

FIG. 7 depicts a flowchart diagram of an eighth embodiment of the present invention; and

FIG. 8 depicts a flowchart diagram of a ninth embodiment of the present invention.

### DETAILED DESCRIPTION

In the following descriptions, the base station and the transmission path creation method thereof according to the present invention will be explained with reference to example embodiments thereof. However, these example embodiments are not intended to limit the present invention to any specific example, embodiment, environment, applications or particular implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

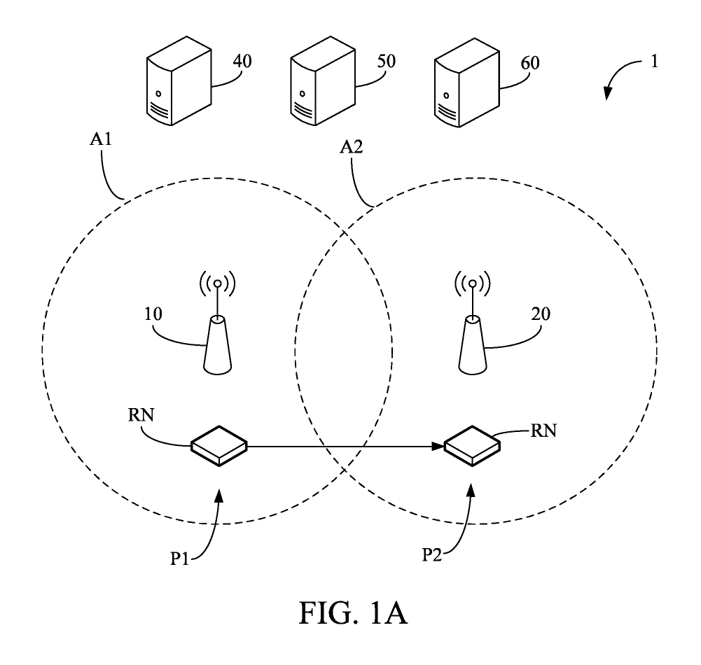

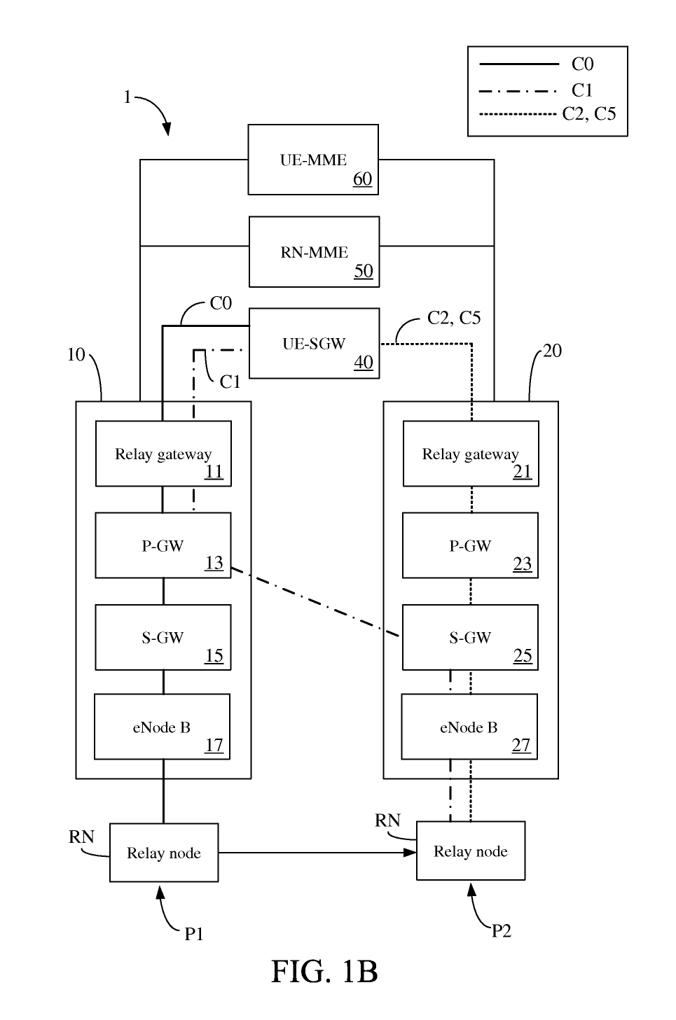

Referring to FIG. 1A and FIG. 1B, a first embodiment of the present invention is depicted therein. FIG. 1A depicts a schematic view of a network system 1 according to the first embodiment, and FIG. 1B depicts a functional block diagram of stations comprised in the network system 1. The network system 1 comprises a plurality of base stations 10, 20, a user equipment serving gateway (UE-SGW) 40, a relay node mobility management entity (RN-MME) 50, a user equipment mobility management entity (UE-MME) 60 and a relay node RN. The base stations 10, 20 have signal coverages A1, A2 respectively.

The base station 10 comprises a relay gateway 11, a packet data network gateway (P-GW) 13, a serving gateway (S-GW) 15 and an E-UTRAN Node B (eNode B) 17; and the base station 20 comprises a relay gateway 21, a P-GW 23, a S-GW 25 and an eNode B 27.

The relay node RN is deployed in an environment (e.g., a carriage of a train) moving at a high speed. The relay node RN moves together as the train moves. Initially, the relay node RN is located at a position P1 within the signal coverage A1, so it is served by the base station 10. Specifically, a packet data network (PDN) connection C0 is formed among the UE-SGW 40, the relay gateway 11, the P-GW 13, the S-GW 15, the eNode B 17 and the relay node RN. When being located in the signal coverage A1, the relay node RN communicates data with the UE-SGW 40 via the PDN connection C0.

The relay node RN then moves from the position P1 towards a position P2 within the signal coverage A2. After the relay node RN moves into the signal coverage A2, the eNode B 27 executes a handover procedure with the relay node RN according to a handover request, and the base station 20 executes a data transmission path creation procedure so that the relay node RN can be served by the base station 20. Therefore, in this embodiment, the base station 10 may be viewed as an initial base station (i.e., a base station that is initially connected with the relay node RN) and a source base station (i.e., a base station that is currently connected with the relay node RN), and the base station 20 may be viewed as a target base station (i.e., a base station that is to be connected with the relay node RN).

Specifically, the eNode B 27 executes the handover procedure with the relay node RN and the base station 10 according to the handover request.

After the handover procedure, a connection is created between the relay gateway 21 and the UE-SGW 40, a connection is created between the P-GW 23 and the relay gateway 21, a connection establish procedure (e.g. a proxy binding update procedure or a create session procedure) is executed between the S-GW 25 and the P-GW 23, and a connection is also created between the S-GW 25 and the eNode B 27.

Through the aforesaid procedure, a PDN connection C2 is formed among the UE-SGW 40, the relay gateway 21, the P-GW 23, the S-GW 25, the eNode B 27 and the relay node RN. Then, if the relay node RN and user equipment (UE) that it serves need to create a new connection after the handover procedure, the relay node RN can communicate data with the UE-SGW 40 via the PDN connection C2.

The PDN connection C0 that is initially created is also adjusted. The eNode B 27 transmits a connection path switch request to the RN-MME 50 so that a relay node path switch procedure is executed among the eNode B 27, the S-GW 25, eNode B 17, the S-GW 15, the P-GW 13 and the RN-MME 50 according to the connection path switch request. Through the relay node path switch procedure, the PDN connection C0 that is initially created is changed to be formed among the UE-SGW 40, the relay gateway 11, the P-GW 13, the S-GW 25, the eNode B 27 and the relay node RN instead (e.g., a PDN connection C1 shown in FIG. 1B).

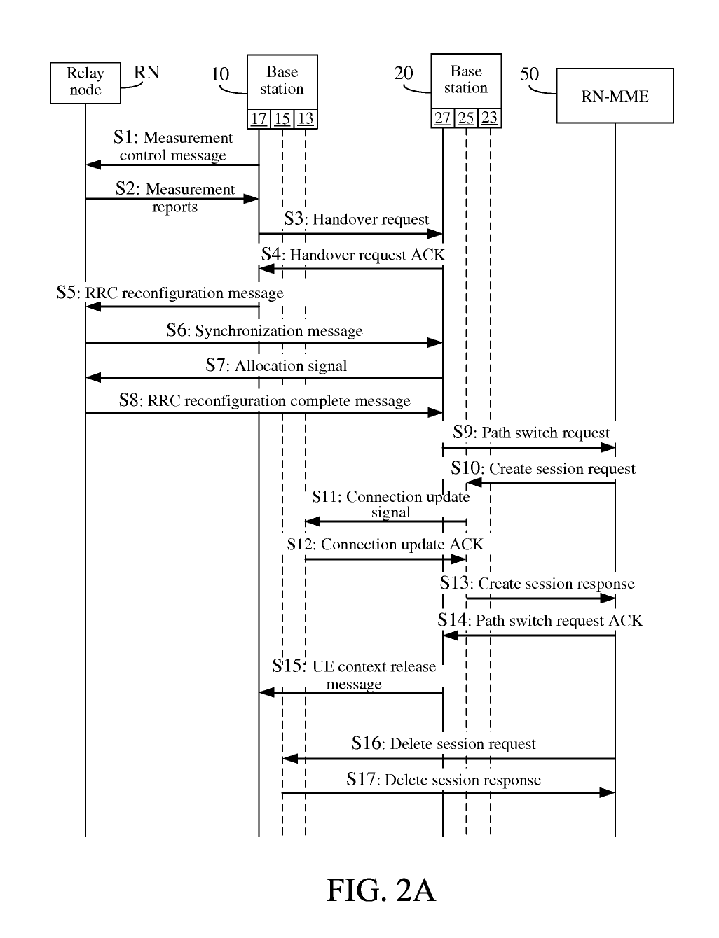

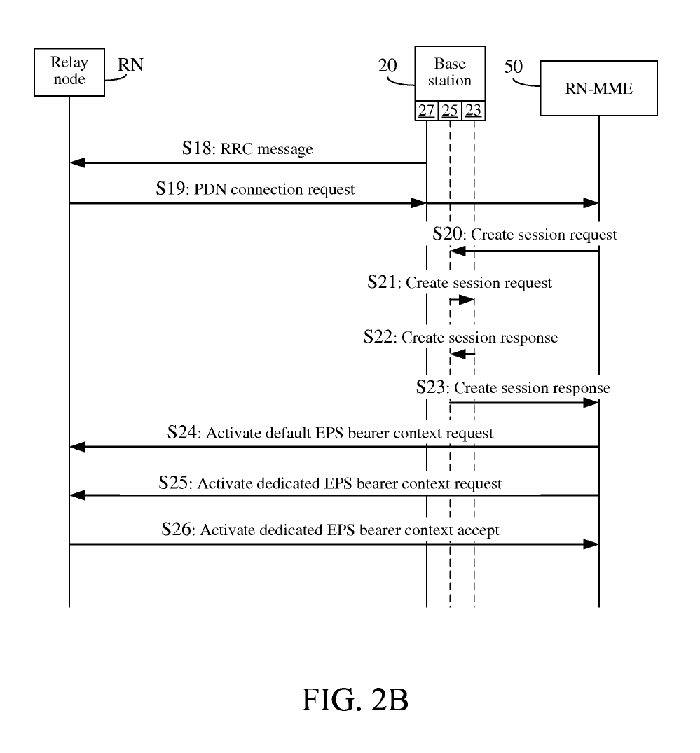

A second embodiment of the present invention is also a network system 1. However, the network system 1 conforms to the Long Term Evolution (LTE) standard. In this case, the base stations 10, 20 may each be a Donor E-UTRAN NodeB (DeNB). FIG. 2A and FIG. 2B depict schematic views of signal transmissions according to the second embodiment.

Firstly, referring to FIG. 2A, the handover procedure executed by the network system 1 conforming to the LTE standard is illustrated by signals S1˜S8. The base station 10 (i.e., the source station) firstly sets an interval at which the relay node RN needs to report signal conditions and sets the type of signals, and the eNode B 17 of the base station 10 transmits a measurement control message S1 to the relay node RN. The relay node RN measures the signal strength of the nearby base station according to the measurement control message S1, and transmits a measurement reports S2 to the eNode B 17 of the base station 10. Then, the base station 10 determines to hand over the relay node RN to the base station 20 (i.e., the target base station) according to the measurement report S2.

Next, the eNode B 17 of the base station 10 transmits a handover request S3 to the eNode B 27 of the base station 20. Messages carried in the handover request S3 include a message for notifying the base station 20 that the equipment to be handed over is a relay node, and include a context related to the relay node RN and the UEs served by the relay node RN. The base station 20 determines, according to the handover request S3, that its own resources are sufficient for the relay node RN and the UEs served by the relay node RN, so the eNode B 27 of the base station 20 transmits a handover request acknowledgement S4 to the eNode B 17 of the base station 10. The handover request acknowledgement S4 at least carries a subframe allocation instruction and a handover random access identification (ID) that is allocated to the relay node RN.

Thereafter, the eNode B 17 of the base station 10 transmits a radio resource control (RRC) reconfiguration message S5 to the relay node RN. After receiving the RRC reconfiguration message S5, the relay node RN is switched into a random access mode. Next, the relay node RN transmits a synchronization message S6 to the eNode B 27 of the base station 20 via a channel corresponding to the handover random access ID. Then, the eNode B 27 transmits an allocation signal S7 to the relay node RN. The allocation signal S7 comprises an uplink allocation grant message and a timing advanced command. The relay node RN transmits an RRC reconfiguration complete message S8 to the eNode B 27 according to the allocation signal S7.

Next, how the RN-MME 50, the eNode B 27, the S-GW 25, eNode B 17, the S-GW 15 and the P-GW 13 execute a relay node path switch procedure through signals S9˜S17 to adjust the initially created PDN connection C0 will be described.

Firstly, the eNode B 27 transmits a path switch request S9 to the RN-MME 50. Then, the RN-MME 50 transmits a create session request S10 to the S-GW 25. Subsequently, the S-GW 25 transmits a connection update signal S11 to the P-GW 13, and the base station 10 updates a context field thereof according to the connection update signal S11. Then, the P-GW 13 returns a connection update acknowledgement S12 to the S-GW 25.

If the network system 1 adopts the proxy mobile Internet protocol (PMIP), then the connection update signal S11 and the connection update acknowledgement S12 are a proxy binding update signal and a proxy binding acknowledgement respectively. If the network system 1 adopts the GPRS Tunnelling Protocol (GTP) protocol of the LTE standard, then the connection update signal S11 and the connection update acknowledgement S12 are a modify bearer request and a modify bearer response respectively.

Upon receiving the connection update acknowledgement S12, the S-GW 25 returns a create session response S13 to the RN-MME 50. Then, the RN-MME 50 returns a path switch request acknowledgement S14 to the eNode B 27. Next, the eNode B 27 transmits a UE context release message S15 to the eNode B 17 so that the base station 10 deletes the context related to the relay node RN according to the UE context release message S15. Then, the RN-MME 50 transmits a delete session request S16 to the S-GW 25, and the S-GW 25 returns a delete session response S17 to the RN-MME 50.

As can be known from the above descriptions, the initially created PDN connection C0 is changed to be formed among the UE-SGW 40, the relay gateway 11, the P-GW 13, the S-GW 25, the eNode B 27 and relay node RN instead (e.g., the PDN connection C1 shown in FIG. 1B) after the relay node path switch procedure is executed by the RN-MME 50, the eNode B 27, the S-GW 25, eNode B 17, the S-GW 15 and the P-GW 13 through the signals S9˜S17.

Next, the following description will focus on how to create a PDN connection C2 (i.e., a PDN connection that is newly created) between the UE-SGW 40 and the relay node RN so that, if the relay node RN and the UEs served by the relay node RN need to transmit data when the relay node RN is located within the signal coverage A2 of the base station 20, the data can be transmitted via the PDN connection C2.

Firstly, the eNode B 27 relays a PDN connection request between the relay node RN and the RN-MME 50 by means of an access point name (APN). Specifically, the eNode B 27 of the base station 20 transmits the APN of the P-GW 23 to the relay node RN by means of an RRC message S18. Then, the relay node RN transmits a PDN connection request S19 comprising the APN to the eNode B 27 so that the eNode B 27 relays the PDN connection request S19 to the RN-MME 50.

Then, the connection establish procedure is executed between the S-GW 25 and the P-GW 23. Specifically, the RN-MME 50 transmits a create session request S20 to the S-GW 25, which then transmits a create session request S21 to the P-GW 23; and the P-GW 23 returns a create session response S22 to the S-GW 25, which then returns a create session response S23 to the RN-MME 50.

Then, the eNode B 27 executes the evolved packet system (EPS) bearer creation procedure with the relay node RN and the RN-MME 50. Specifically, the RN-MME 50 transmits an activate default EPS bearer context request S24 to the relay node RN to preset the created PDN connection C2 as a default transmission path of UEs that are served by the relay node RN when being located within the signal coverage A2. Next, the RN-MME 50 transmits an activate dedicated EPS bearer context request S25 to the relay node RN, and the activate dedicated EPS bearer context request S25 can designate more than one dedicated evolved PDN connection. Subsequently, the relay node RN designates in the activate dedicated EPS bearer context request S25 one of the more than one dedicated evolved PDN connection, and then returns an activate dedicated EPS bearer context accept message S26.

Through signals S18˜S26, the PDN connection C2 is formed among the UE-SGW 40, the relay gateway 21, the P-GW 23; the S-GW 25, the eNode B 27 and the relay node RN. Thereafter, if the UEs served by the relay node RN are to create a new PDN connection when the relay node RN is still located within the signal coverage A2, the relay node RN will transmit data of the UEs via the PDN connection C2.

In addition to the aforesaid steps, the second embodiment can also execute all the operations and functions set forth in the first embodiment. How the second embodiment executes these operations and functions can be readily appreciated by those of ordinary skill in the art based on the explanation of the first embodiment, and thus will not be further described herein.

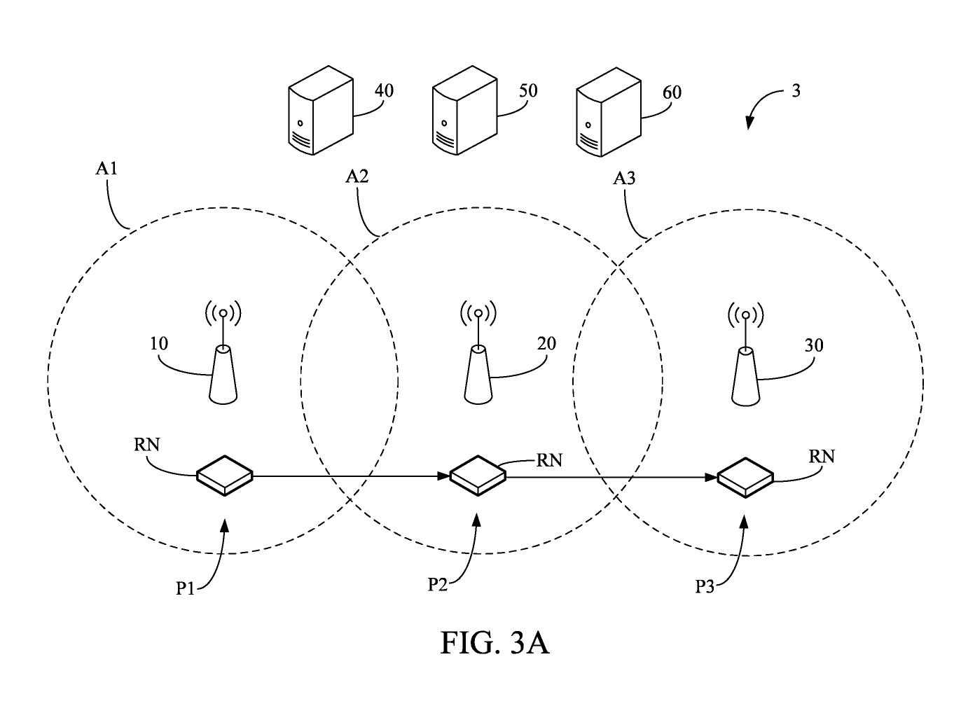

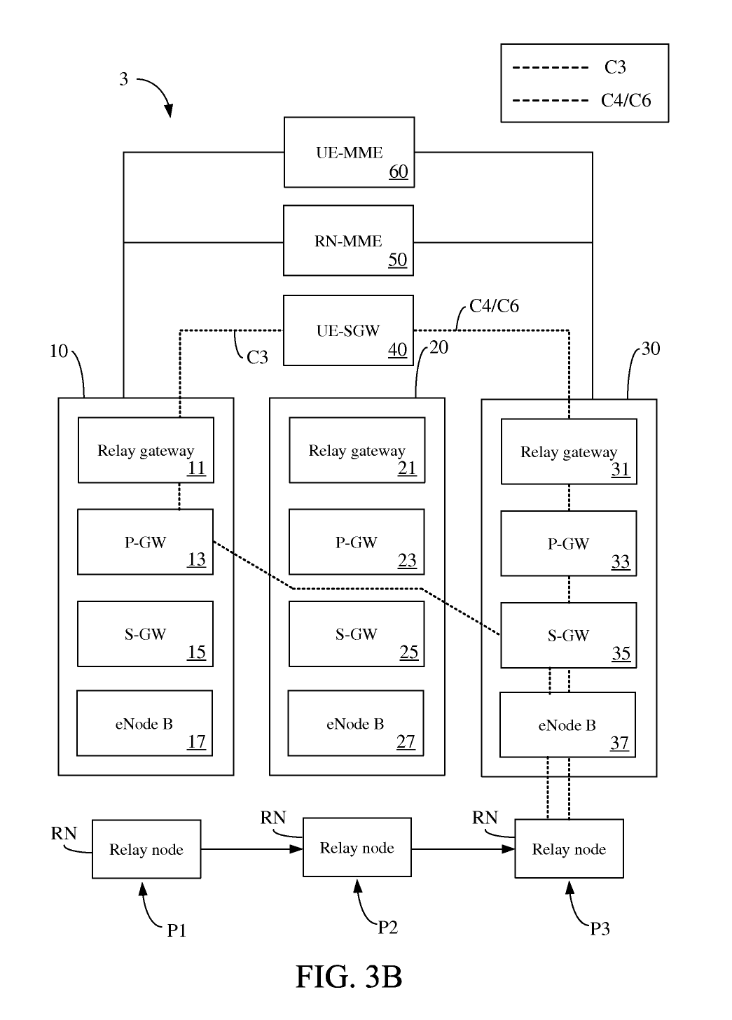

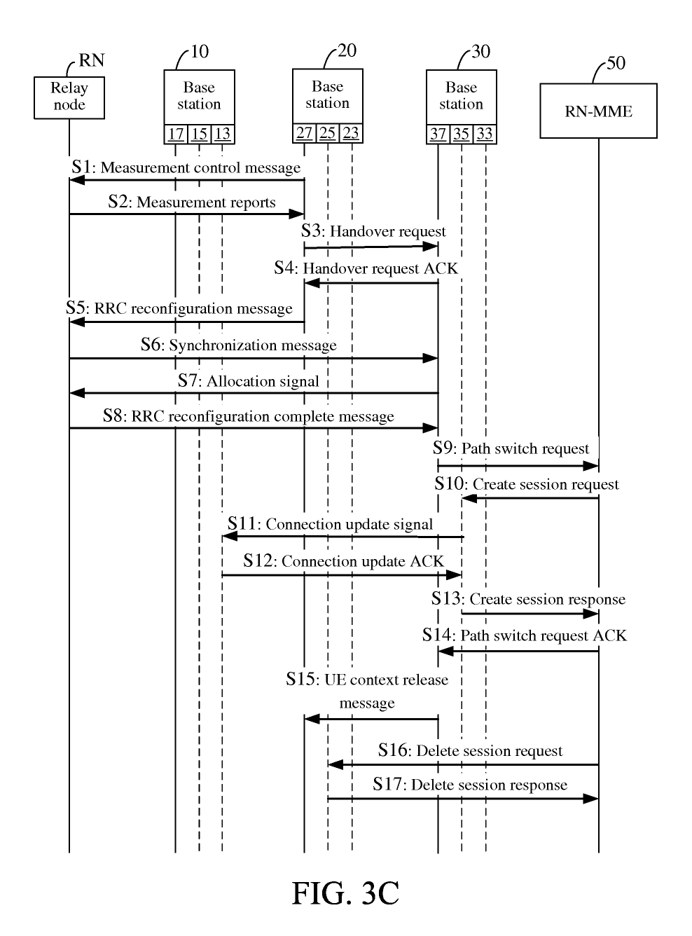

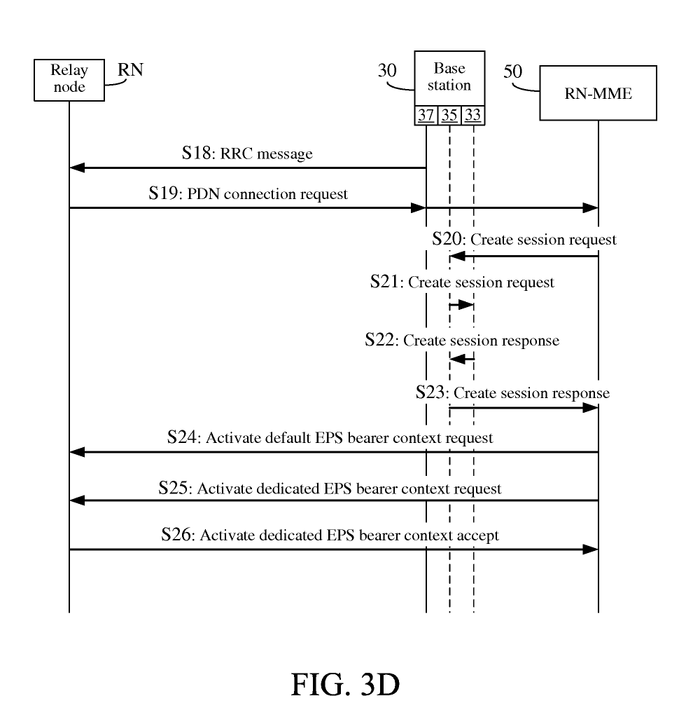

Referring to FIG. 3A, FIG. 3B, FIG. 3C and FIG. 3D, a third embodiment of the present invention is depicted therein. FIG. 3A depicts a schematic view of a network system 3 of the third embodiment; FIG. 3B depicts a functional block diagram of stations comprised in the network system 3; and FIG. 3C and FIG. 3D depict schematic views of signal transmissions of this embodiment.

In addition to all of the devices and the stations comprised in the network system 1, the network system 3 further comprises a base station 30. Furthermore, the network system 3 conforms to the LTE standard. The base station 30 has a signal coverage A3, and comprises a relay gateway 31, a P-GW 33, an S-GW 35 and an eNode B 37. Likewise, the devices and the modules of the base station 30 have the same functions and can execute the same operations as those of the base stations 10, 20.

In this embodiment, the relay node RN moves from a position P1 to a position P2, and then moves from the position P2 to a position P3 within the signal coverage A3. As the procedures that need to be executed when the relay node RN moves from the position P1 to the position P2 have been described in the first and the second embodiments, the following description will only focus on procedures that need to be executed when the relay node RN moves from the position P2 to the position P3.

When the relay node RN is at the position P2, the relay node RN and the UEs served by the relay node RN use the PDN connections C1, C2 as shown in FIG. 1B. The PDN connection C1 is formed among the UE-SGW 40, the relay gateway 11, the P-GW 13, the S-GW 25 and the eNode B 27, and the PDN connection C2 is formed among the UE-SGW 40, the relay gateway 21, the P-GW 23, the S-GW 25, the eNode B 27 and the relay node RN.

When the relay node RN moves from the position P2 to the position P3, the base stations 10, 20, 30 may be viewed as an initial base station, a source base station and a target base station respectively. Because the base station 30 is the target base station, the operations executed by the target base station (i.e., the base station 20) in the first and the second embodiments will be executed by the base station 30 in this embodiment.

Refer to FIG. 3C and FIG. 3D, which are schematic views of signal transmissions. This embodiment uses the same signal designations as the first and the second embodiments, so the signals with the same designations will not be further described herein. The following description will only focus on differences of this embodiment from the first and the second embodiments.

Refer to FIG. 3C firstly. Firstly, the eNode B 37 executes a handover procedure with the relay node RN and the base station 20 through signals S1˜S8. Specifically, the eNode B 27 of the base station 20 firstly transmits a measurement control message S1 to the relay node RN; then, the relay node RN transmits a measurement report S2 to the eNode B 27; and the base station 20 determines to hand over the relay node RN to the base station 30 according to the measurement report S2.

Next, the eNode B 27 of the base station 20 transmits a handover request S3 to the eNode B 37 of the base station 30. The base station 30 determines that it can execute a handover procedure with the relay node RN according to the contents of the handover request S3, so the eNode B 37 of the base station 30 returns a handover request acknowledgement S4 to the eNode B 27.

Subsequently, the eNode B 27 transmits an RRC reconfiguration message S5 to the relay node RN so that the relay node RN is switched into a random access mode according to the RRC reconfiguration message S5. Next, the relay node RN transmits a synchronization message S6 to the eNode B 37 via a channel corresponding to the handover random access ID. Then, the eNode B 37 returns an allocation signal S7 to the relay node RN, and the relay node RN further transmits an RRC reconfiguration complete message S8 to the eNode B 37.

Next, how the RN-MME 50, the eNode B 37, the S-GW 35, the eNode B 27, the S-GW 25 and the P-GW 13 execute a relay node path switch procedure through signals S9˜S17 to adjust the PDN connection C1 will be described.

Firstly, the eNode B 37 transmits a path switch request S9 to the RN-MME 50, and the RN-MME 50 further transmits a create session request S10 to the S-GW 35. Then, the S-GW 35 transmits a connection update signal S11 to the P-GW 13, and the P-GW 13 returns a connection update acknowledgement S12 to the S-GW 35.

Subsequently, the S-GW 35 returns a create session response S13 to the RN-MME 50, which then returns a path switch request acknowledgement S14 to the eNode B 37. Next, the eNode B 37 transmits a UE context release message S15 to the eNode B 27. Then, the RN-MME 50 transmits a delete session request S16 to the S-GW 25, and the S-GW 25 returns a delete session response S17 to the RN-MME 50.

As can be known from the above descriptions, the PDN connection C1 is changed to be formed among the UE-SGW 40, the relay gateway 11, the P-GW 13, the S-GW 35, the eNode B 37 and the relay node RN instead (e.g., a PDN connection C3 shown in FIG. 3B) after the relay node path switch procedure is executed by the RN-MME 50, the eNode B 37, the S-GW 35, the eNode B 27, the S-GW 25 and the P-GW 13 through the signals S9˜S17.

Thus, when the relay node RN moves from the position P2 to the position P3, the data transmission that is originally carried out via the PDN connection C1 will be carried out via the PDN connection C3 instead. For the PDN connection C2, it will also be changed through the same process flow in this embodiment, and this will not be further described herein.

Furthermore, a new PDN connection C4 is further created between the UE-SGW 40 and the relay node RN, as shown in FIG. 3D. For the creation of the PDN connection C4, reference may be made to the explanation of the first and the second embodiments and the signal transmissions of FIG. 3C. With respect to operations of creating the new PDN connection C4, this embodiment differs from the first and the second embodiments in that the transmission path is created by the relay node RN, the base station 30 and the RN-MME 50; however, the signals S18˜S26 used in this embodiment are the same as those described previously and, thus, will not be further described herein.

Thereafter, if the UEs served by the relay node RN are to create a new PDN connection when the relay node RN is located within the signal coverage A3, the relay node RN will transmit data of the UEs via the PDN connection C4.

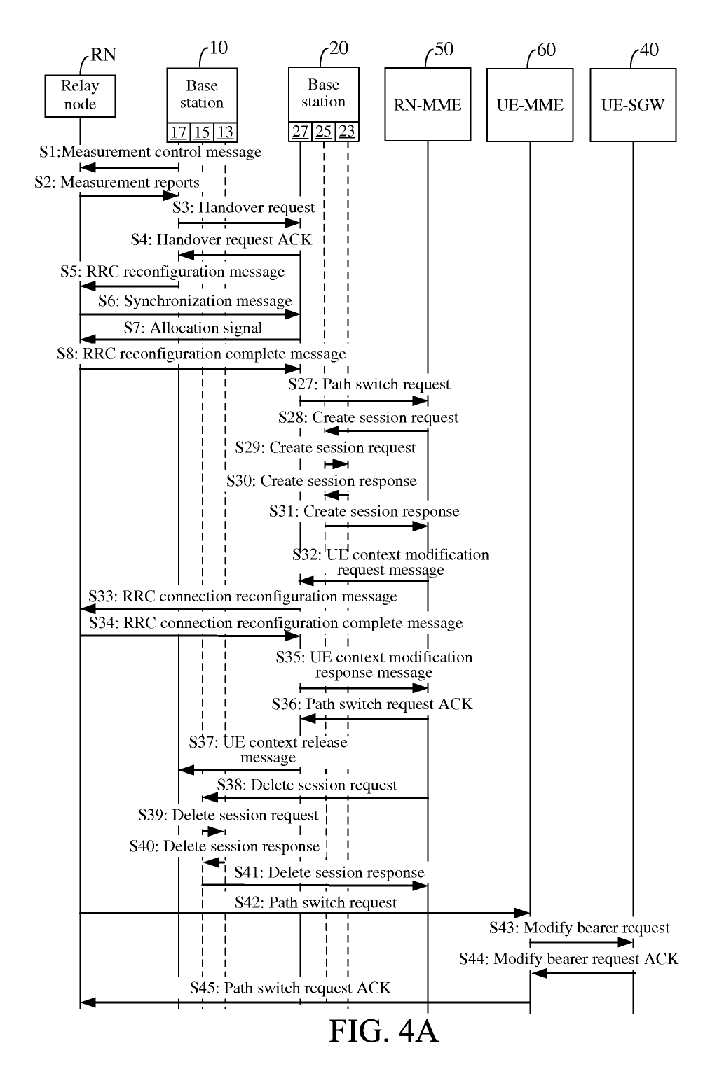

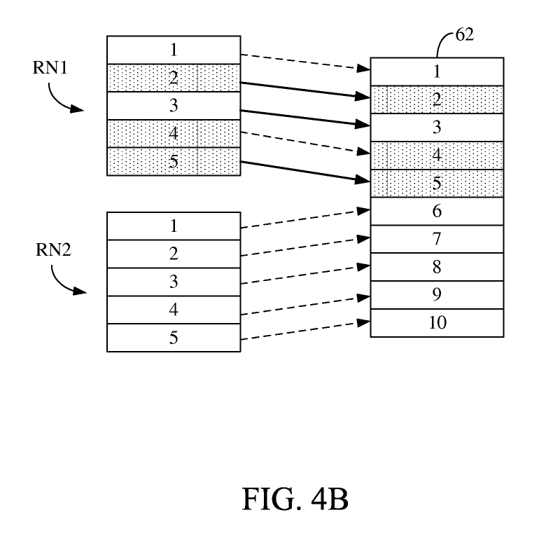

Refer to FIG. 1A, FIG. 1B, FIG. 4A and FIG. 4B for a fourth embodiment of the present invention. The fourth embodiment is also adapted for use in the network system 1 shown in FIG. 1A. The fourth embodiment differs from the second embodiment in how to change the original PDN connection (e.g., the PDN connection C0). Briefly speaking, the P-GW 13 used by the PDN connection C0 is not changed in the second embodiment; however, in the fourth embodiment, the P-GW 13 used by the PDN connection C0 will also be changed.

Referring to FIG. 4A, a handover procedure is also executed through the signals S1˜S8 in this embodiment. Execution of the signals S1˜S8 is the same as that of the second embodiment and, thus, will not be further described herein.

Next, how the UE-SGW 40, the RN-MME 50, the UE-MME 60, the eNode B 17, the S-GW 15, the P-GW 13, the eNode B 27, the S-GW 25, the P-GW 23 and the relay node RN execute a relay node path switch procedure through signals S27˜S45 will be described.

Firstly, the eNode B 27 transmits a path switch request S27 to the RN-MME 50. The path switch request S27 comprises an Internet protocol (IP) address of the S-GW 25 that is embedded in the base station 20. Subsequently, the RN-MME 50 transmits a create session request S28 to the S-GW 25, and the S-GW 25 transmits a create session request S29 to the P-GW 23. Then, the P-GW 23 allocates a new IP address to the relay node RN, and the new IP address is placed in a create session response S30 which is then transmitted by the P-GW 23 to the S-GW 25. A connection establish procedure can be established between the S-GW 25 and the P-GW 23 through the signals S29˜S30.

Then, the S-GW 25 transmits to the RN-MME 50 a create session response S31 carrying the new IP address of the relay node RN. At this point, the RN-MME 50 transmits the new IP address of the relay node RN to the relay node RN, which will be described as follows. The RN-MME 50 transmits a UE context modification request message S32 carrying a non-access stratum (NAS) signal to the eNode B 27. The NAS signal carries an activate default EPS bearer context request. Then, the eNode B 27 transmits an RRC connection reconfiguration message S33 carrying the activate default EPS bearer context request to the relay node RN.

Next, the relay node RN transmits to the eNode B 27 an RRC connection reconfiguration complete message S34 carrying an activate default EPS bearer context accept message of an NAS signal. Subsequently, the eNode B 27 transmits to the RN-MME 50 a UE context modification response message S35 carrying the activate default EPS bearer context accept message. After the new IP address of the relay node RN is transmitted to the relay node RN by the RN-MME 50, the RN-MME 50 returns a path switch request acknowledgement S36 to the eNode B 27, and the eNode B 27 then transmits a UE context release message S37 to the eNode B 17 so that the base station 10 deletes the context of the relay node RN according to the UE context release message S37.

Then, the RN-MME 50 transmits a delete session request S38 to the S-GW 15 so that, according to the delete session request S38, the base station 10 deletes the PDN connection and the context created for the relay node RN. Furthermore, the S-GW 15 transmits a delete session request S39 to the P-GW 13 so that the P-GW 13 deletes the PDN connection and the context created for the relay node RN. Then, the P-GW 13 transmits a delete session response S40 to the S-GW 15, which then returns a delete session response S41 to the RN-MME 50.

Thereafter, the relay gateway 21 further executes a UE path switch procedure with the relay node RN, the UE-MME 60 and the UE-SGW 40, which will be detailed as follows.

The relay node RN transmits a path switch request S42 comprising a group ID through the relay gateway 21 to the UE-MME 60. Subsequently, the UE-MME 60 transmits a modify bearer request S43 to the UE-SGW 40; and then according to the group ID carried in the modify bearer request, the UE-SGW 40 determines which UEs of the relay node RN will switch their connection paths from the base station 10 to the base station 20. Then, the UE-SGW 40 transmits a modify bearer request acknowledgement S44 to the UE-MME 60. Finally, the UE-SGW 40 adds an end marker in the data finally transmitted, and stops transmitting data related to the UEs served by the relay node RN to the base station 10. After receiving the modify bearer request acknowledgement S44, the UE-MME 60 returns a path switch request acknowledgement S45 through the relay gateway 21 to the relay node RN.

It shall be particularly appreciated that, the UE context release message S37 may be transmitted after the path switch request acknowledgement S36 or after the path switch request acknowledgement S45.

Through the aforesaid procedure, the PDN connection C0 has been changed to be formed among the UE-SGW 40, the relay gateway 21, the P-GW 23, the S-GW 25, the eNode B 27 and the relay node RN instead (e.g., a PDN connection C5 shown in FIG. 1B). The UEs served by the relay node RN then transmit data via the PDN connection C5.

It shall be particularly appreciated that, because the P-GW of the original PDN connection is changed in this embodiment, all the UEs served by the relay node RN must have the UE IDs thereof changed, and this would lead to a large number of signallings in the core network to cause congestion of the core network. The present invention also provides a solution to this, that is, changes the paths of the UEs in the form of a group (replacing the UE IDs with a group ID), with the group ID being carried in the aforesaid path switch request S42. Hereinbelow, two implementations of the group ID will be described.

In a first implementation, a relay node ID is used as the group ID, and a database 62 of the UE-MME 60 stores the UE IDs and an index of the corresponding relay node ID. Therefore, when the path switch request S42 is executed, path switch can be executed simultaneously for all the UEs served by the relay node RN simply according to the relay node ID. In other words, there is no need to switch the paths one by one through use of the UE IDs.

In a second implementation, the relay node ID and a bit map are used as the group ID so that path switch can be executed for only some of the UEs of the relay node RN. If this implementation is adopted, then the database 62 of the UE-MME 60 needs to record the relay node ID and the UE IDs. One of the recording manners is shown in FIG. 4B.

Suppose that the network system comprises two relay nodes RN1, RN2. The relay node RN1 serves five UEs, which are represented by serial numbers 1˜5 respectively; and the relay node RN2 also serves five UEs, which are also represented by serial numbers 1˜5 respectively. FIG. 4B depicts correspondence relationships between the serial numbers and the indices in the database 62. That is, the indices 1˜5 correspond to the five UEs 1˜5 served by the relay node RN1 respectively, and the indices 6˜10 correspond to the five UEs 1˜5 served by the relay node RN2 respectively in the database 62.

For example, if the paths of the UEs 2, 4 and 5 served by the relay node RN1 need to be changed now, then the group ID carried in the path switch request S42 must comprise the relay node ID of the relay node RN1 and a bit map. The bit map is configured to represent serial numbers (i.e., 2, 4 and 5) in the database 62 of the UE-MME 60 which correspond to the UEs 2, 4 and 5 served by the relay node RN1. Thus, path switch can be executed for only particular UEs simply by transmitting the relay node ID and a bit map. This can improve the problem with the prior art that a large number of UE IDs need to be carried in a message to make the message lengthy and the data massive.

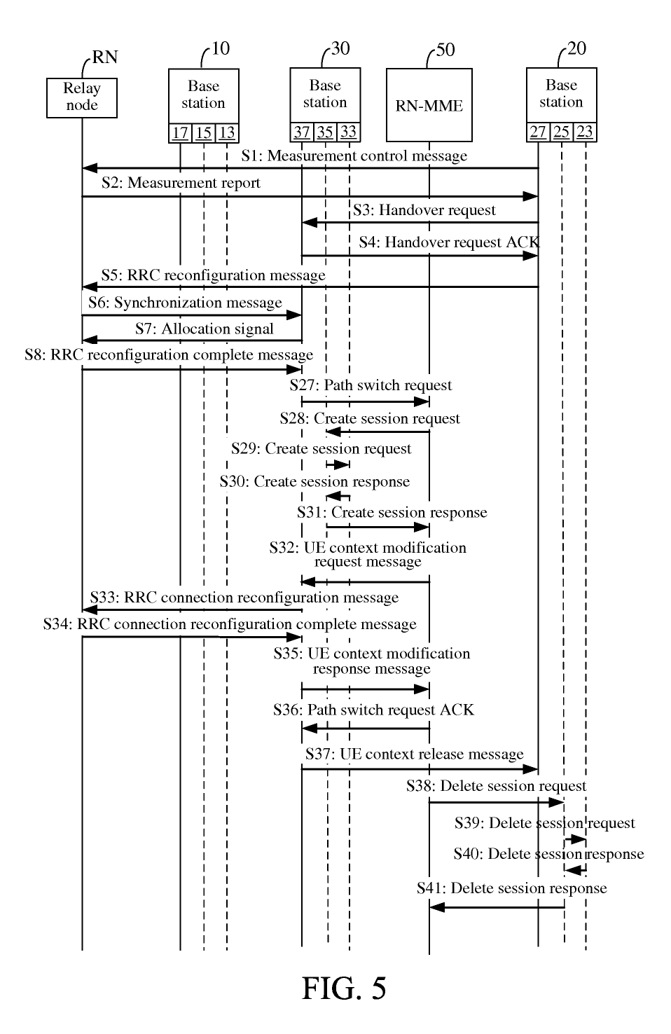

Refer to FIG. 1B, FIG. 3A, FIG. 3B and FIG. 5 for a fifth embodiment of the present invention. The fifth embodiment is also adapted for use in the network system 3 shown in FIG. 3A. The fifth embodiment differs from the third embodiment in how to change the original PDN connection. Briefly speaking, the P-GW used by the original PDN connection is not changed in the third embodiment; however, in the fifth embodiment, the P-GW used by the PDN connection will also be changed.

In this embodiment, the relay node RN moves from a position P1 to a position P2, and then moves from the position P2 to a position P3. As the procedures that need to be executed when the relay node RN moves from the position P1 to the position P2 have been described in the fourth embodiment, the following description will focus on only procedures that need to be executed when the relay node RN moves from the position P2 to the position P3. Therefore, the base stations 10, 20, 30 may be viewed as an initial base station, a source base station and a target base station respectively.

When the relay node RN is at the position P2, the relay node RN and the UEs served by the relay node RN use the PDN connections C2, C5 as shown in FIG. 1B. Both the PDN connections C2, C5 are formed among the UE-SGW 40, the relay gateway 21, the P-GW 23, the S-GW 25, the eNode B 27 and the relay node RN.

Referring to FIG. 5, as the signals S1˜S8 described in the third embodiment a handover procedure is also executed through the signals S1˜S8 in this embodiment, and this will not be further described herein. The UE-SGW 40, the RN-MME 50, the UE-MME 60, the S-GW 15, the P-GW 13, the eNode B 37, the S-GW 35, the P-GW 33, the eNode B 27 and the relay node RN execute a relay node path switch procedure through use of signals S27˜S45. In this embodiment, the signals S27˜S36 are changed from being associated with the base station 20 to being associated with the base station 30; so no further description will be made thereon.

In this embodiment, the UE context release message S37 is transmitted by the eNode B 37 of the base station 30 to the eNode B 27 of the base station 20. The delete session request S38 is transmitted by the RN-MME 50 to the S-GW 25. Then, the delete session request S39 is transmitted by the S-GW 25 to the P-GW 23. After that, the delete session response S40 is transmitted by the P-GW 23 to the S-GW 25, and the delete session response S41 is transmitted by the S-GW 25 to the RN-MME 50. Wherein the functions of the signals S38˜S41 are same with whose of the signals S38˜S41 described in the fourth embodiment, so no further description will be made thereon. In addition, the signals S41˜S45 are same with which described in FIG. 4, so no further description will be made thereon and no further drawing in the FIG. 5.

Through execution of the signals S1˜S8 and S27˜S45, the original PDN connections C2, C5 can be changed into a PDN connection C6 formed among the UE-SGW 40, the relay gateway 31, the P-GW 33, the S-GW 35, the eNode B 37 and the relay node RN.

It shall be appreciated that, in the first to the fifth embodiments, a tracking area update procedure may further be executed by the target base station (the base station 20 or 30) or the relay node RN; i.e., in which base station coverage the relay node RN is currently located can be confirmed by the target base station or the relay node RN.

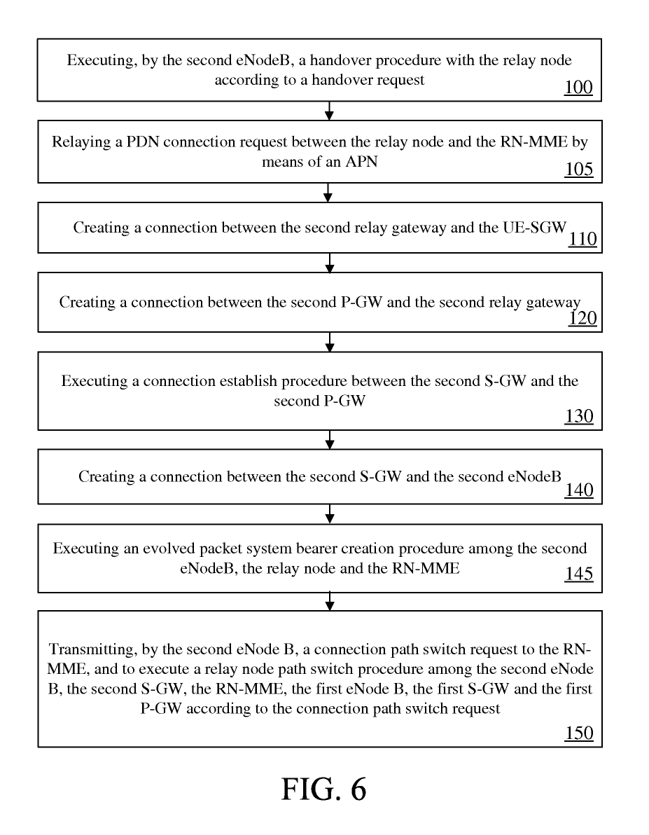

A sixth embodiment of the present invention is a transmission path creation method, a flowchart diagram of which is depicted in FIG. 6. The transmission path creation method is adapted for use in a base station serving as a target base station. A network system comprises a target base station, a relay node, a UE-SGW, an RN-MME and an initial base station (which also serves as a source base station). The initial base station comprises a first relay gateway, a first P-GW, a first S-GW and a first eNode B. A first PDN connection is formed among the UE-SGW, the first relay gateway, the first P-GW, the first S-GW, the first eNode B and the relay node. The relay node communicates data with the UE-SGW via the first PDN connection originally. The target base station comprises a second eNode B, a second relay gateway, a second P-GW and a second S-GW.

Firstly, step 100 is executed to execute, by the second eNode B, a handover procedure (e.g., the signals S1˜S8 in the aforesaid embodiments) with the relay node according to a handover request. Then, step 105 is executed to relay, by the second eNode B, a PDN connection request between the relay node and the RN-MME by means of an APN. Subsequently, step 110 is executed to create a connection between the second relay gateway and the UE-SGW. Further, step 120 is executed to create a connection between the second P-GW and the second relay gateway. Next, step 130 is executed to execute a connection establish procedure between the second S-GW and the second P-GW. Thereafter, step 140 is executed to create a connection between the second S-GW and the second eNode B. Then, step 145 is executed to execute an evolved packet system bearer creation procedure among the second eNode B, the relay node and the RN-MME. It shall be particularly appreciated herein that, the steps 105˜445 can be accomplished through the signals S18˜S26 described in the second embodiment when the network system conforms to the LTE standard.

After the step 145 is executed, a second PDN connection is formed among the UE-SGW, the second relay gateway, the second P-GW, the second S-GW, the second eNode B and the relay node so that the relay node communicates data with the UE-SGW via the second PDN connection after the handover procedure.

Furthermore, step 150 is further executed to transmit, by the second eNode B, a connection path switch request to the RN-MME, and to execute a relay node path switch procedure among the second eNode B, the second S-GW, the RN-MME, the first eNode B, the first S-GW and the first P-GW according to the connection path switch request. Thus, the first PDN connection is changed to be formed among the UE-SGW, the first relay gateway, the first P-GW, the second S-GW, the second eNode B and the relay node instead. It shall be particularly appreciated herein that, the step 150 can be accomplished through execution of the signals S9˜S17 described in the second embodiment when the network system conforms to the LTE standard.

A seventh embodiment of the present invention is also a transmission path creation method, a flowchart diagram of which is also depicted in FIG. 6. The transmission path creation method is also adapted for use in a base station serving as a target base station, but is applied in scenarios where the source base station and the initial base station are different base stations.

A network system comprises a target base station, a relay node, a UE-SGW, an RN-MME, an initial base station and a source base station. The initial base station comprises a first relay gateway and a first P-GW, and the source base station comprises a first S-GW and a first eNode B. A first PDN connection is formed among the UE-SGW, a first relay gateway, the first P-GW, the first S-GW, the first eNode B and the relay node. The relay node communicates data with the UE-SGW via the first PDN connection originally. Furthermore, the target base station comprises a second eNode B, a second relay gateway, a second P-GW and a second S-GW.

Steps 100˜145 of the transmission path creation method of this embodiment are the same as those of the sixth embodiment. After the step 145 is executed, a second PDN connection is formed among the UE-SGW, the second relay gateway, the second P-GW, the second S-GW, the second eNode B and the relay node so that the relay node communicates data with the UE-SGW via the second PDN connection after the handover procedure.

Furthermore, step 150 is further executed to transmit, by the second eNode B, a connection path switch request to the RN-MME, and to execute a relay node path switch procedure among the second eNode B, the second S-GW, the RN-MME, the first eNode B, the first S-GW and the first P-GW according to the connection path switch request. It shall be particularly appreciated that, in this embodiment, the first PDN connection is changed to be formed among the UE-SGW, the first relay gateway comprised in the initial base station, the first P-GW comprised in the initial base station, the second S-GW, the second eNode B and the relay node instead. It shall be particularly appreciated herein that, the step 150 can be accomplished through execution of the signals S9˜S17 described in the third embodiment when the network system conforms to the LTE standard.

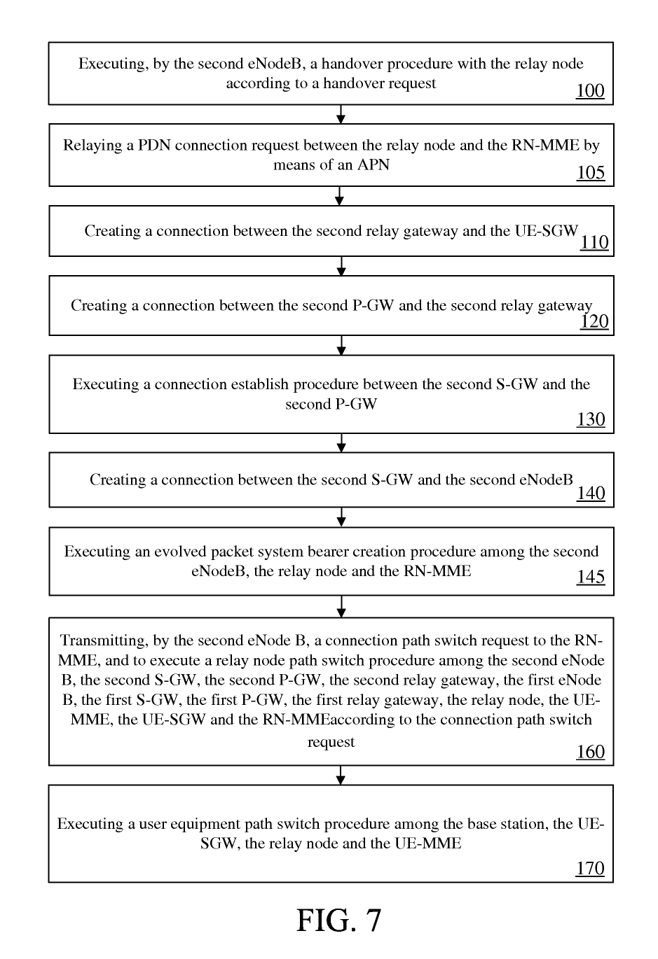

An eighth embodiment of the present invention is a transmission path creation method, a flowchart diagram of which is depicted in FIG. 7. The transmission path creation method is adapted for use in a base station serving as a target base station. A network system comprises a target base station, a relay node, a UE-SGW, an RN-MME, a UE-MME and an initial base station (which also serves as a source base station). The initial base station comprises a first relay gateway, a first P-GW, a first S-GW and a first eNode B. A first PDN connection is formed among the UE-SGW, the first relay gateway, the first P-GW, the first S-GW, the first eNode B and the relay node. The relay node communicates data with the UE-SGW via the first PDN connection originally. The target base station comprises a second relay gateway, a second eNode B, a second P-GW and a second S-GW.

In the transmission path creation method of this embodiment, steps 100˜445 are firstly executed. The steps 100˜445 are the same as those of the sixth and the seventh embodiments and, thus, will not be further described herein. After the step 145 is executed, a second PDN connection is formed among the UE-SGW, the second relay gateway, the second P-GW, the second S-GW, the second eNode B and the relay node so that the relay node communicates data with the UE-SGW via the second PDN connection after the handover procedure.

Furthermore, step 160 is further executed to transmit, by the second eNode B, a connection path switch request to the RN-MME, and to execute a relay node path switch procedure among the second eNode B, the second S-GW, the second P-GW, the second relay gateway, the first eNode B, the first S-GW, the first P-GW, the first relay gateway, the relay node, the UE-MME, the UE-SGW and the RN-MME according to the connection path switch request so that the first PDN connection is changed to be formed among the UE-SGW, the second relay gateway, the second P-GW, the second S-GW, the second eNode B and the relay node instead.

Further speaking, the relay node can serve a plurality of UEs which communicate data with the UE-SGW via the first P-GW and the first S-GW originally.

It shall be appreciated that, in this embodiment, the data transmission paths of the UEs served by the relay node must be adjusted because the P-GW used by the first PDN connection has been changed into the second P-GW. Specifically, step 170 is further executed to execute a user equipment path switch procedure among the target base station, the UE-SGW, the relay node and the UE-MME according to a user equipment path switch request carrying a relay node ID. Through the user equipment path switch procedure, the UEs change to communicate data with the UE-SGW via the second P-GW and the second S-GW instead.

Furthermore, the user equipment path switch request may further carry a bit map so that the UE-MME can learn serial numbers of individual UEs whose paths need to be switched. For example, the relay node serves a first UE and a second UE; and if the user equipment path switch procedure only needs to be executed on the first UE, then a serial number corresponding to the first UE can be transmitted through the bit map. It shall be particularly appreciated herein that, the steps 100˜145, 160 and the step 170 can be accomplished through execution of the signals S1˜S45 described in the fourth embodiment when the network system conforms to the LTE standard.

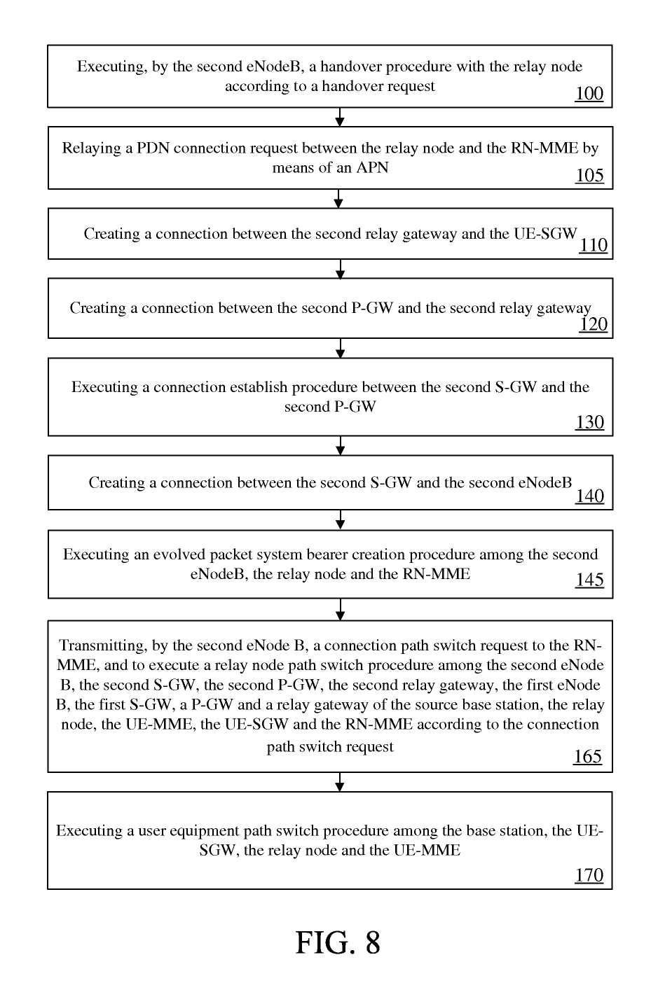

A ninth embodiment of the present invention is also a transmission path creation method, a flowchart diagram of which is also depicted in FIG. 8. The transmission path creation method is adapted for use in a base station serving as a target base station. A network system comprises a target base station, a relay node, a UE-SGW, an RN-MME, a UE-MME, an initial base station and a source base station. The initial base station comprises a first relay gateway and a first P-GW, and the source base station comprises a first S-GW and a first eNode B.

A first PDN connection is formed among the UE-SGW, a first relay gateway, the first P-GW, the first S-GW, the first eNode B and relay node. The relay node communicates data with the UE-SGW via the first PDN connection originally. The target base station comprises a second eNode B, a second relay gateway, a second P-GW and a second S-GW.

In the transmission path creation method of this embodiment, steps 100˜445 are also executed firstly. The steps 100˜445 are the same as those of the sixth, the seventh and the eighth embodiments and, thus, will not be further described herein. Thereafter, a second PDN connection is formed among the UE-SGW, the second relay gateway, the second P-GW, the second S-GW, the second eNode B and the relay node so that the relay node communicates data with the UE-SGW via the second PDN connection after the handover procedure.

Furthermore, step 165 is further executed to transmit, by the second eNode B, a connection path switch request to the RN-MME, and to execute a relay node path switch procedure among the second eNode B, the second S-GW, the second P-GW, the second relay gateway, the first eNode B, the first S-GW, a P-GW of the source base station, a relay gateway of the source base station, the relay node, the UE-MME, the UE-SGW and the RN-MME according to the connection path switch request. Through the step 165, the first PDN connection is changed to be formed among the UE-SGW, the second relay gateway, the second P-GW, the second S-GW, the second eNode B and the relay node instead.

Further speaking, the relay node can serve a plurality of UEs which communicate data with the UE-SGW via the first P-GW and the first S-GW originally.

It shall be appreciated that, in this embodiment, the data transmission paths of the UEs served by the relay node must be adjusted because the P-GW used by the first PDN connection has been changed into the second P-GW. Specifically, step 170 is further executed to execute a user equipment path switch procedure among the target base station, the UE-SGW, the relay node and the UE-MME according to a user equipment path switch request carrying a relay node ID. Through the user equipment path switch procedure, the UEs change to communicate data with the UE-SGW via the second P-GW and the second S-GW instead.

It shall be additionally appreciated that, the steps 100˜445, 165 and 170 can be accomplished through execution of the signals S1˜S45 described in the fifth embodiment when the network system conforms to the LTE standard.

According to the above descriptions, the base station and the transmission path creation method thereof of the present invention can minimize the connection path, and this can prevent the connection path from increasing with the distance from the initial base station in an environment moving at a high speed. With the solutions of the present invention, information can be transmitted more efficiently via a shorter transmission path even in the environment moving at a high speed.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station for use in a network system, the network system comprising the base station, a relay node, a user equipment serving gateway (UE-SGW), a first relay node mobility management entity (RN-MME), a first relay gateway, a first packet data network gateway (P-GW), a first serving gateway (S-GW) and a first E-UTRAN Node B (eNode B), a first packet data network (PDN) connection being formed among the UE-SGW, the first relay gateway, the first P-GW, the first S-GW and the first eNode B, and the relay node communicating data with the UE-SGW via the first PDN connection, the base station comprising:
a second eNode B, being configured to execute a handover procedure with the relay node according to a handover request;
a second relay gateway, being configured to create a connection with the UE-SGW after the handover procedure;
a second P-GW, being configured to create a connection with the second relay gateway after the handover procedure; and
a second S-GW, being configured to execute a connection establish procedure with the second P-GW and to create a connection with the second eNode B after the handover procedure so that the relay node communicates data with the UE-SGW via a second PDN connection after the handover procedure, wherein the second PDN connection is formed among the UE-SGW, the second relay gateway, the second P-GW, the second S-GW, the second eNode B, and the relay node.

2. The base station as claimed in claim 1, wherein the network system further comprises an initial base station which comprises a first relay gateway, the first P-GW, the first S-GW and the first eNode B;
wherein the handover request is from the initial base station, and the handover procedure is further executed between the second eNode B and the initial base station.

3. The base station as claimed in claim 1, wherein the network system further comprises an initial base station and a source base station, the initial base station comprises a first relay gateway, the first P-GW, and the source base station comprises the first S-GW and the first eNode B;
wherein the handover request is from the source base station, and the handover procedure is further executed between the second eNode B and the source base station.

4. The base station as claimed in claim 1, wherein the second PDN connection has an access point name (APN), the second eNode B further relays a PDN connection request between the relay node and the RN-MME by means of the APN so that the second S-GW and the second P-GW execute the connection establish procedure, and the second eNodeB, the relay node and the RN-MME further executes an evolved packet system bearer creation procedure after the connection establish procedure.

5. The base station as claimed in claim 4, wherein the second eNode B further transmits a connection path switch request to the RN-MME, and the second eNode B, the second S-GW, the RN-MME and the first P-GW further execute a relay node path switch procedure according to the connection path switch request so that the first PDN connection is changed to be formed among the UE-SGW, the first relay gateway, the first P-GW, the second S-GW and the second eNode B instead.

6. The base station as claimed in claim 1, wherein the second eNode B further transmits a connection path switch request to the RN-MME, and the second eNode B, the second S-GW, the second P-GW, a first relay gateway, the relay node, the UE-SGW and the RN-MME further execute a relay node path switch procedure according to the connection path switch request so that the first PDN connection is changed to be formed among the UE-SGW, the second relay gateway, the second P-GW, the second S-GW and the second eNode B instead.

7. The base station as claimed in claim 6, wherein the network system further comprises a user equipment mobility management entity (UE-MME), the relay node serves a plurality of pieces of user equipment (UEs) which communicate data with the UE-SGW via the first relay gateway, the first P-GW and the first S-GW, and the relay gateway further executes a user equipment path switch procedure with the relay node, the UE-SGW and the UE-MME according to a user equipment path switch request carrying a relay node identification (ID) so that the UEs change to communicate data with the UE-SGW via the second relay gateway, the second P-GW and the second S-GW instead.

8. The base station as claimed in claim 6, wherein the network system further comprises a UE-MME, the relay node serves a first UE and a second UE, the first UE and the second UE communicate data with the UE-SGW via the first relay gateway, the first P-GW and the first S-GW, and the relay gateway further executes a user equipment path switch procedure with the relay node, the UE-SGW and the UE-MME according to a user equipment path switch request so that the first UE changes to communicate data with the UE-SGW via the second relay gateway, the second P-GW and the second S-GW instead, wherein the user equipment path switch request carries a relay node ID and a bit map that corresponds to the first UE.

9. A transmission path creation method adapted for use in a base station of a network system, the network system comprising the base station, a relay node, a UE-SGW, an RN-MME, a first relay gateway, a first P-GW, a first S-GW and a first eNode B, a first PDN connection being formed among the UE-SGW, the first relay gateway, the first P-GW, the first S-GW and the first eNode B, a first PDN connection being formed among the UE-SGW, the first relay gateway, the first P-GW, the first S-GW and the first eNode B, and the relay node communicating data with the UE-SGW via the first PDN connection, the base station comprising a second eNode B, a second relay gateway, a second P-GW and a second S-GW, the transmission path creation method comprising the steps of:
executing, by the second eNode B, a handover procedure with the relay node according to a handover request;
creating a connection between the second relay gateway and the UE-SGW after the handover procedure;
creating a connection between the second P-GW and the second relay gateway after the handover procedure;
executing a connection establish procedure between the second S-GW and the second P-GW after the handover procedure;
creating a connection between the second S-GW and the second eNode B after the handover procedure so that the relay node communicates data with the UE-SGW via a second PDN connection after the handover procedure, wherein the second PDN connection is formed among the UE-SGW, the second relay gateway, the second P-GW, the second S-GW, the second eNode B and the relay node.

10. The transmission path creation method as claimed in claim 9, wherein the network system further comprises an initial base station which comprises a first relay gateway, the first P-GW, the first S-GW and the first eNode B;
wherein the handover request is from the initial base station, and the handover procedure is further executed between the second eNode B and the initial base station.

11. The transmission path creation method as claimed in claim 9, wherein the network system further comprises an initial base station and a source base station, the initial base station comprises a first relay gateway, the first P-GW, and the source base station comprises the first S-GW and the first eNode B;
wherein the handover request is from the source base station, and the handover procedure is further executed between the second eNode B and the source base station.

12. The transmission path creation method as claimed in claim 9, wherein the second PDN connection has an access point name (APN), the transmission path creation method further comprising the steps of:
relaying a PDN connection request between the relay node and the RN-MME by means of the APN after the handover procedure so that the second S-GW and the second P-GW execute the connection establish procedure;
executing an evolved packet system bearer creation procedure among the second eNodeB, the relay node and the RN-MME after the connection establish procedure.

13. The transmission path creation method as claimed in claim 12, further comprising the steps of:
transmitting, by the second eNode B, a connection path switch request to the RN-MME; and
executing a relay node path switch procedure among the second eNode B, the second S-GW, the RN-MME and the first P-GW according to the connection path switch request so that the first PDN connection is changed to be formed among the UE-SGW, the first relay gateway, the first P-GW, the second S-GW and the second eNode B instead.

14. The transmission path creation method as claimed in claim 9, further comprising the steps of:
transmitting, by the second eNode B, a connection path switch request to the RN-MME; and
executing a relay node path switch procedure among the second eNode B, the second S-GW, the second P-GW, the second relay gateway, the relay node, the UE-SGW and the RN-MME according to the connection path switch request so that the first PDN connection is changed to be formed among the UE-SGW, the second relay gateway, the second P-GW, the second S-GW and the second eNode B instead.

15. The transmission path creation method as claimed in claim 14, wherein the network system further comprises a UE-MME, the relay node serves a plurality of UEs which communicate data with the UE-SGW via the first relay gateway, the first P-GW and the first S-GW, and the transmission path creation method further comprises the step of:
executing a user equipment path switch procedure among the base station, the UE-SGW, the relay node and the UE-MME according to a user equipment path switch request carrying a relay node ID so that the UEs change to communicate data with the UE-SGW via the second relay gateway, the second P-GW and the second S-GW instead.

16. The transmission path creation method as claimed in claim 14, wherein the network system further comprises a UE-MME, the relay node serves a first UE and a second UE, the first UE and the second UE communicate data with the UE-SGW via the first relay gateway, the first P-GW and the first S-GW, and the transmission path creation method further comprises the step of:
executing a user equipment path switch procedure among the base station, the UE-SGW, the relay node and the UE-MME according to a user equipment path switch request so that the first UE changes to communicate data with the UE-SGW via the second relay gateway, the second P-GW and the second S-GW instead, wherein the user equipment path switch request carries a relay node ID and a bit map that corresponds to the first UE.
